(19) United States
(12) Patent Application Publication
(10) Pub. No.: US 2026/0130369 A1
(43) Pub. Date: May 14, 2026

(54) MARINE ALGICIDES

(71) Applicant: Mote Marine Laboratory, Inc., Sarasota, FL (US)

(72) Inventor: Dana L. Wetzel, Sarasota, FL (US)

(21) Appl. No.: 19/118,488

(22) PCT Filed: Oct. 6, 2023
(86) PCT No.: PCT/US2023/034664

§ 371 Date: Apr. 4, 2025

Related U.S. Application Data
(60) Provisional application No. 63/413,858, filed on Oct. 6, 2022.

(51) Int. Cl. A01N 37/36; A01N 25/02; A01N 25/26; A01N 37/06; A01P 13/00

(52) U.S. Cl. CPC A01N 37/36; A01N 25/02; A01N 25/26; A01N 37/06; A01P 13/00

(57) ABSTRACT

Harmful algal blooms (HABs) such as red tide blooms can be mitigated or controlled by applying a water-soluble algicidal unsaturated fatty acid salt or soap, or a methanol-free solution of an unsaturated algicidal fatty acid, to water containing a HAB concentration, wherein the salt, soap or solution reduces the HAB concentration.

### CROSS-REFERENCE TO RELATED APPLICATION

This application claims the benefit of U.S. Provisional Application No. 63/413,858 filed Oct. 6, 2022 and entitled “BREVETOXIN ALGICIDES”, the disclosure of which is hereby incorporated by reference in its entirety.

### TECHNICAL FIELD

This invention relates to methods and materials for mitigation and control of Harmful Algal Blooms (HABs) in water, for example “red tide”, and to agents for biocontrol of such HABs in water.

### BACKGROUND

HABs such as red tide and other algal blooms are a worldwide problem, and can be especially severe in and around the Gulf of Mexico. Red tide algal blooms are caused by Karenia brevis, a dinoflagellate species that produces several brevetoxin (BT) compounds including both parent BT compounds and metabolite BT species (collectively. BTXs). Although most prevalent along the southwest Florida coast, and sometimes lasting over a year, red tide blooms have occurred along the entire US and Mexico Gulf coasts, and along the Atlantic coast as far north as North Carolina. BTXs are neurotoxic to a wide variety of organisms. Human consumption of bivalve mollusks (e.g., clams, oysters, mussels and scallops) containing sufficiently high BTX levels can lead to neurotoxic shellfish poisoning (NSP). Though BTXs tend to accumulate most significantly in shellfish, contamination of other marine organisms also commonly occurs.

Wave action lyses K. brevis, particularly during blooms due the increase in the algal population density, causing the toxins to enter the water and then become aerosolized as sea spray. Aerosolized brevetoxins can be carried onshore by sea spray and produce respiratory distress among beachgoers and coastal residents. Exposure to the aerosolized toxins may result in eye and throat irritation, nasal congestion, cough, wheezing, shortness of breath, and further complications in individuals with chronic inflammatory lung conditions. Once airborne, aerosolized brevetoxins may further contaminate inland waters, crops, and other susceptible substances, substrates, and sites.

Conventional methods for red tide control have generally focused on addressing impacts, without combatting K. brevis directly. With the increasing size and frequency of HABs like those caused by K. brevis, methods for combatting these blooms are being explored. Chemical agents such as hydrogen peroxide and copper sulfate have been used for their algicide effects to deter or eliminate blooms, but their broad-spectrum effects can have extremely deleterious impacts on the overall marine ecosystem. Various biological agents, such as viruses, bacteria, planktonic ciliates, and heterotrophic dinoflagellates have also been explored, but suffer from disadvantages including difficulty of application and high cost.

One possible avenue to limit such expansive ecological damage is through controlled application of other marine organisms that may have an inhibitive allelopathic effect on chemical signaling by and between algae in the bloom (see e.g., Jin and Dong. Comparative studies on the allelopathic effects of two different strains of Ulva pertusa on Heterosigma akashiwo and Alexandrium tamarense, Journal of Experimental Marine Biology and Ecology 293, 41-55 (2003), and relating to algae that produce biotoxins, albeit not BTXs). Other studies have found that macroalgae, in particular, can have a strong inhibitory effect on several species associated with HABs (see e.g., Tang and Gobler. The green macroalga, Ulva lactuca, inhibits the growth of seven common harmful algal bloom species via allelopathy, Harmful Algae 10, 480-88). Also, Alamsjah et al., Isolation and structure determination of algicidal compounds from Ulva fasciata, Biosci. Biotechnol. Biochem., 69 (11), 2186-92 (2005) and Alamsjah et al., Algicidal activity of polyunsaturated fatty acids derived from Ulva fasciata and U. pertusa (Ulvaceae, Chlorophyta) on phytoplankton, Journal of Applied Phycology 20 (5) 713-20) (2009) report the methanol extraction of several fatty acids from Ulva fasciata and Ulva pertussa green algae and the evaluation of methanol solutions of such extracts, methanol solutions of several commercially-purchased fatty acids, and dry powders made from Ulva fasciata and Ulva pertusa for algicidal activity against Heterosigma akashiwo microalgae and several phytoplankton species.

### SUMMARY

There remains an unmet need for more effective and efficient systems and methods for reducing the prevalence and severity of K. brevis blooms and other HABs, and for reducing BTX and other marine biotoxin levels in public waters, bivalve farms, and other harvest areas. There further remains an unmet need for a reliable means of actively combatting the growing size and frequency of K. brevis blooms and other HABs. The present disclosure addresses such needs.

Many or even most fatty acids are oily liquids, and as noted by Alamsjah et al. in the above-mentioned 2009 paper. “fatty acids are hydrophobic substances with a very limited solubility in water”. The use of methanolic solutions to apply fatty acids to bodies of water could be potentially toxic to marine life and humans, as well as an expensive mode of administration. The application of dry powdered substances containing fatty acids (e.g., the above-mentioned and dry powders made from Ulva fasciata and Ulva pertusa) may provide algicidal activity at somewhat lower LC₅₀ levels than methanolic solutions, but can still require large dry powder doses.

Disclosed herein are methods for Harmful Algal Bloom (HAB) mitigation or control, comprising the step of:
applying a water-soluble algicidal unsaturated fatty acid salt or soap, or a methanol-free solution of an unsaturated algicidal fatty acid, to water containing a HAB concentration, wherein the salt, soap or methanol-free solution reduces the HAB concentration.

Also disclosed herein are compositions for Harmful Algal Bloom (HAB) mitigation or control, comprising a dispersion of water-soluble algicidal unsaturated fatty acid salt or soap particles in a water column containing a HAB concentration, wherein the salt or soap particles will dissolve and will reduce the HAB concentration.

In embodiments, the water may be selected from open water (e.g., seawater), flowing water, or other water that can contain a HAB.

In embodiments, the HAB may comprise diatoms, dinoflagellates, cyanobacteria, or Karenia brevis. In some embodiments, the HAB may comprise the New Pass, Wilson, Wilson LT, or Manasota Key strains of Karenia brevis.

In some embodiments, the water-soluble salt of an algicidal unsaturated marine fatty acid may be encapsulated in a water-soluble shell.

In some embodiments, a gravimetric agent may be added to the water-soluble salt of the algicidal unsaturated marine fatty acid.

The above summary is not intended to describe each illustrated embodiment or every implementation of the subject matter hereof. The figures and the detailed description that follow more particularly exemplify various embodiments.

### BRIEF DESCRIPTION OF THE DRAWING

Subject matter hereof may be more completely understood in consideration of the following detailed description of various embodiments in connection with the accompanying figures, in which:

FIG. 1 is a perspective view of an individual flow-through toxicity glass test chamber.

FIG. 2 is a schematic of a continuous flow toxicity exposure system.

FIG. 3 shows fluorescence imaging of K. brevis using Invitrogen™ SYTOX™ Green stain.

FIG. 4 is a series of graphs showing the concentration of three strains of K. Brevis after treatment with algaecides.

FIG. 5 is a plot showing K. brevis mortality with algaecide treatment.

FIG. 6 and FIG. 7 are graphs showing K. brevis survival rates after exposure to several algicidal unsaturated fatty acids and salts.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The term “algicidal” means inducing mortality of harmful algae. An “algicidal agent” is a compound that induced mortality of harmful algae.

The term “concentration” when used with respect to a HAB means the HAB population as microscopically determined using staining and cell counts.

The term “dispersant” means a substance capable of dispersing a compound in a liquid medium, such as water.

The term “emulsifier” means a substance that acts as a stabilizer for an emulsion.

The term “emulsion” means a stable or semi-stable dispersion of an immiscible compound in a liquid.

The term “encapsulated” means a compound, e.g., an algicidal agent, at least partially enclosed in a capsule, which capsule optionally may at least partially include or enclose other substances such as surfactants, emulsifiers, dispersants, gravimetric agents, solvents, or the like.

The term “fatty acid” means a compound comprising a carboxylic acid with at least one aliphatic hydrocarbon chain.

The term “gravimetric agent” means a substance that increases the weight of a compound so that its density is greater than that of seawater.

As noted above, the term “HAB” means a harmful algal bloom. HABs may include a variety of toxin producing algae species.

The term “HAB concentration” means a concentration of a harmful algal bloom in water or other liquid.

The term “marine,” when used with respect to a fatty acid, means compounds that are present in a marine environment or would not be unacceptably toxic to fish, shellfish and other desirable aquatic species.

The term “monounsaturated” means a fatty acid that has one double or triple bond between carbon atoms.

The term “mortality” means the death of HABs caused by an algicidal agent, and as determined using cell counts to evaluate concentration reduction compared to a control sample not containing the algicidal agent.

The term “polyunsaturated” means a fatty acid that comprises more than one double or triple bond between carbon atoms.

The term “salt” means a compound containing cations, such as sodium, potassium, magnesium, ammonium, or the like.

The term “substantially methanol-free” means an amount of methanol less than about 5 wt. %, less than about 3 wt. %, less than about 1 wt. %, less than about 0.5 wt. %, or less than about 0.1 wt. % based on the weight of the polyunsaturated fatty acid or salt.

The term “unsaturated” means a fatty acid having carbon-carbon double or triple bonds between carbon atoms. Unsaturated fatty acids may be monounsaturated or polyunsaturated.

The term “water-soluble” means a compound that may be dissolved in water, and may for example be at least 5 mg/L, at least 15 mg/L, at least 25 mg/L, or at least 50 mg/L at 25° C.

The present disclosure relates to algicidal agents that can be used for HAB mitigation and control using a comprehensive systematic approach. The disclosed agents may be applied to a variety of HABs, including diatoms, dinoflagellates, cyanobacteria, Karenia brevis, and other toxin-producing harmful algae. There are numerous strains of K. brevis, and the disclosure herein includes detailed treatment data for the New Pass, Wilson, Wilson LT, and Manasota Key strains. However, other strains of K. brevis and other toxin producing algae may be treated using the methods, compositions and systems described herein. Some embodiments of the present disclosure may also be used as biocontrol agents for other algicidal applications, for example as an herbicide for some species of undesirable aquatic plants.

Shown below in Table 1 are one saturated fatty acid (viz., palmitic acid) and nine exemplary algicidal unsaturated fatty acids, along with their omega nomenclature (viz., number of carbon atoms, number of double bonds, number of carbon atoms from the carboxylic acid end to the first carbon in a double bond) and the required dosage in ppm to obtain 100% mortality of K. brevis, within 2 hours after administration to a water sample containing K. brevis, according to embodiments of the present disclosure. Some of the ppm values include a > or < symbol, indicating that further testing for those compounds may be performed to provide additional mortality efficacy data.

TABLE 1

| | Omega | Dosage (PPM) for 100% |
|---|---|---|
| Systematic Name | Nomenclature | Mortality in under 2 hrs |
| Palmitic Acid | 16:0 | >10 |
| Palmitoleic Acid | 16:1 n7 | 3 |
| Hexadecatetraenoic Acid | 16:4 n3 | >1 |
| Vacennic Acid | 18:1 n7 | >6 |
| Alpha-linolenic Acid | 18:3 n3 | 3 |
| Stearidonic Acid | 18:4 n3 | >2 |
| Arachidonic Acid | 20:4 n6 | 1.5 |
| Eicosapentaenoic Acid | 20:5 n3 | <2 |
| Adrenic Acid | 22:4 n6 | <50 |
| Docosahexanoic Acid | 22:6 n3 | <2.5 |

The relative toxic effects shown in Table 1 were determined by obtaining individual pure compounds and testing them against red tide cultures of K. brevis. The compounds in Table 1 may also be tested as salts or soaps, and in water or non-methanolic solvents such as ethanol, acetone, acetic acid, dimethyl sulfoxide (DMSO) or other polar or non-polar solvent. The lower the concentration of the compound that still shows significant mortality, the better it may serve for mitigating or controlling HABs including red tide blooms. In embodiments, the observed mortality may for example be at least 25%, at least 50%, at least 75%, at least 90% or as much as 100% in a desired time frame (e.g., within 2 hours, within 4 hours, within 8 hours, within 24 hours, or within 2, 3 or 4 days following application of the algicidal compound. In some embodiments, 100% death of red tide organisms may be achieved within 30 minutes of application within a target area. Additionally, extracts of macro algae common in environments suitable for K. brevis were tested to see how the mixture of fatty acids in those extracts would perform as algicidal agents. Use of a single compound instead of a mixture may be preferable under many common circumstances. However, Ulva latuca and Gracilaria tikvahiae contain mixtures of fatty acids and may be used as salts or soaps or in non-methanolic solutions to control K. brevis red tide blooms, according to embodiments of the present disclosure.

In embodiments, the algicidal agents disclosed herein may be salts or soaps of monounsaturated or polyunsaturated fatty acids, with fatty acids whose salts or soaps include a hydroxyl group (e.g., ricinoleic acid and compounds containing ricinoleic acid such as castor oil) being preferred when the algicidal agent is monounsaturated. Shown below in Table 2 are several exemplary fatty acids or fatty acid-containing materials and their sodium or potassium salts, together with their omega nomenclature and CAS numbers.

TABLE 2

| | Omega | |
|---|---|---|
| Systematic Name | Nomenclature | CAS Number |
| Palmitoleic acid | 16:1n7 | 373-49-9 |
| Sodium Palmitoleate | | 6610-24-8 |
| Potassium Palmitoleate | | 18175-44-5 |
| alpha-linolenic acid | 18:3n3 | 463-40-1 |
| Sodium linolenate | | 822-18-4 |
| Potassium linolenate | | 3414-89-9 |
| Ricinoleic acid | 18:1 | 141-22-0 |
| Sodium Ricinolenate | | 5323-95-5 |
| Potassium Ricinolenate | | 7492-30-0 |
| Castor Oil | NA | 8001-79-4 |
| Sodium Castorate | | 8013-06-7 |
| Potassium Castorate | | 8013-05-6 |
| Linseed Oil | NA | 8001-26-1 |
| Linseed oil, sodium salt | | 68554-56-3 |
| Linseed oil, potassium salt | | 68605-13-0 |

Algicidal mortality results for several of the algicidal agents in Table 2 are shown below in the Examples section.

The disclosed fatty acid algicides may be in the form of pure or crude formulations, or as water-soluble salts or soaps of substances containing substantial quantities of fatty acids. Exemplary purity levels may for example be at least 40 wt. %, at least 50 wt. %, at least 60 wt. %, at least 70 wt. %, at least 80 wt. % or at least 90 wt. % f the desired fatty acid, salt or soap, The disclosed algicidal agents preferably are pure or crude materials derived from plants, such as castor oil, linseed oil, safflower oil, sunflower oil and tall oil. The disclosed algicidal agents preferably are non-toxic to marine life (e.g., fish, shellfish and other invertebrates, and marine mammals) when present at dosages sufficient to mitigate or control HABs. The disclosed algicidal agents may act as cell membrane disruptors to K. brevis, damaging the cell membrane of K. brevis cells and causing the cells to die, thereby reducing red tide concentration sin water. Algicidal agents that are toxic to K. brevis may also be referred to as brevicidal.

In some embodiments, the algicidal agents are in the form of water-soluble salts of a desired fatty acid. In some embodiments, the water-soluble salt is a solid at 25° C. Exemplary salts include alkali metal cations, such as sodium, potassium or magnesium cations, ammonium cations, zinc cations, and the like. In some embodiments the algicidal agents are in the form of water-soluble soaps made by saponification of a desired fatty acid ester. Exemplary soaps include sodium, potassium and ammonium soaps.

In some embodiments, the algicidal agents may be food-grade materials, and in some embodiments the algicidal agents may be approved as pesticides or as inert ingredients by the U.S. Environmental Protection Agency (EPA). In some embodiments, the algicidal agents comprise C₈-C₁₂, C₁₂-C₁₈ or C₁₆-C₂₂ alkyl chains. For example, in some embodiments, the algicidal agents comprise a potassium salt or soap of a C₁₂-C₁₈ unsaturated fatty acid, as such compounds are already approved for use as pesticides by the EPA. Also, in some embodiments the algicidal agents comprise an ammonium salt or soap of a C₈-C₁₂ unsaturated fatty acid, as such compounds are also already approved for use as pesticides by the EPA. In some embodiments the algicidal agents comprise linseed oil, castor oil or a salt or soap thereof, as linseed oil and castor oil are already approved by the EPA as inert ingredients. In some embodiments the algicidal agents comprise at least one of a salt or soap (e.g., a potassium or ammonium salt or soap) of alpha-linolenic acid, palmitoleic acid, stearidonic acid, ricinoleic acid, arachidonic acid, docosahexaenoic acid, eicosapentaenoic acid, oleic acid, linoleic acid, trans-vaccenic acid, cis-vaccenic acid, linseed oil or castor oil. In some embodiments, the algicidal agents comprise at least one of linolenic acid, hexadecatetraenoic acid (C16:4 n1), octadecatetraenoic acid (C18:4 n3), palmitelaidic acid (trans-C16:1 n7), and erucic acid (C22:1 n9).

In some embodiments, non-methanolic organic solvents may be used to assist in dissolving the algicidal agents. In some embodiments, dispersants or emulsifiers may be added to the algicidal agents to disperse or emulsify them in liquid. In some embodiments, the algicidal agents may be provided in dry powder or solid forms, and such forms may include encapsulated, prilled, spray dried, roll dried or agglomerated (e.g., fluid bed agglomerated) particles. For example, to disperse the disclosed algicidal agents in water-soluble shells, the agent may be dissolved in ethanol and blown through a tube into an atmosphere saturated with a suitable encapsulation material such as an alginate and dried to form capsules in water-soluble shells. Other suitable encapsulation materials may comprise at least one of chitosan, chitin, xanthan, dextran, cyclodextrin, gellan, pullulan, mannan, hyaluronic acid, agarose, guar gum, sucrose, trehalose, and pectin. The shells may be substantially sphere-shaped or may have other shapes as desired. In embodiments, the water-soluble shells may have varying thicknesses, e.g., to affect how quickly the capsules dissolve in water.

K. brevis and other toxin producing harmful algae may migrate throughout the water column at different depths depending on light conditions. Accordingly, deploying the disclosed treatment system in a body of water may desirably include dispersing solid particles containing the algicidal agents along the length of the water column. In embodiments, the particles have varied dissolution rates and densities. Encapsulation processes and additives may be used to change the properties of the particles, such as their solubility, buoyancy, rate of dissolution, and the like. Gravimetric agents may be added to change buoyancy and cause the particles to sink (or to sink more rapidly) in water. Exemplary gravimetric agents may include crushed stone, sand, crushed shells of invertebrates, or any other suitable marine alternative. Other additives may be used to make the capsules neutrally buoyant (viz., so the density of the capsules is the same density as the water they are immersed in) so that the capsules do not sink to the bottom or rise to the top of the water column. In embodiments, encapsulated particles may include other additives such as charcoal or clay particles that may be embedded in the capsules or used to coat the capsule shells. In embodiments, a treatment system is disclosed for adding capsules to a body of water that comprises a mixture of capsules of algicidal agents that have regular buoyancy (viz., float at the surface of water), capsules of neutral buoyancy, and capsules with an additive that causes the capsules to sink in water. In embodiments, batches of capsules with different properties may be added to water. For example, a batch may include capsules with varying densities so that the capsules sink to different positions in a water column, or different batches of varying densities may be added to a water column sequentially to disperse capsules throughout the entire column. In other embodiments, large solid tablets comprising the algicidal agents may be used. The tablets may include effervescent agents to aid dissolution of the tablet, for example by increasing the dissolution rate.

In some embodiments the algicidal agents may include antioxidants. In some embodiments relatively oxidation-resistant algicidal agents (e.g., ricinoleic acid and its salts and soaps) can be stored for long periods of time and employed without antioxidants.

In embodiments, the algicidal agents may be present in treated water at concentrations at least about 0.1 ppm, at least about 0.5 ppm, at least about 1 ppm, at least about 2 ppm, at least about 3 ppm, at least about 4 ppm, or at least about 50 ppm, and up to about 100 ppm, up to about 50 ppm, up to about 30 ppm, up to about 20 ppm, or up to about 10 ppm.

Application and dispersal of the algicidal agents disclosed herein may be by any appropriate method, such as by spray dispersal by airplane or helicopter; injection or spray dispersal from a water vessel, roving underwater vehicle, or buoy; or direct deposit from a shoreline, lakeshore, canal bank or dock.

Protocols for toxicity testing of algicidal compounds for the potential mitigation of Karenia brevis are also described. Algicidal chemicals may be classified as herbicides, and in some jurisdictions may need to be registered with a local environmental protection agency to be used. To evaluate candidate algicidal chemicals for environmental safety, toxicity testing of these compounds is carried out to meet the required test guidelines for algicidal mitigation in a marine or estuary environment.

### Example 1

### Toxicity Test for Estuarine and Marine Organisms

A large-scale mesocosm experiment was conducted to evaluate the efficacy of algicide treatment and marine organism toxicity. In each of four 1400 L exposure tanks containing K. brevis cells at a red tide concentration of 1 million cells/L, potassium ricinoleate particles were added to the tanks at levels of 15 or 25 ppm. At 15 minutes after addition of the algicidal agent to each tank, water samples were collected for red tide cell counts. Each tank had complete red tide cell mortality (viz., no live cells under microscopic examination) at the first (15 minute) sampling period.

Marine organism toxicity was evaluated by adding grass shrimp or Gulf killifish to the tanks along with the red tide cells and 15 or 25 ppm of the algicidal compounds. The red tide cells were quickly killed as before. After 18 and 24 hours, all shrimp remained alive. After 18 hours all fish were alive, but significant fish mortality was observed after 24 hours. The fish mortality was determined to be due to insufficient tank water circulation and oxygenation, and repeating the fish experiment with adequate circulation and oxygenation should eliminate or at least reduce the observed fish mortality.

### Example 2

### Toxicity Exposure System

Constant flow-through chambers and exposure systems for candidate algicidal agent toxicity testing may be like the chamber initially described by Singer et al. (Singer, M. M., D. L. Smalheer and R. S. Tjeerdema. 1990a. A Simple Continuous-Flow Toxicity), with subsequent modifications to improve the analytical accuracy, convenience of use, and organism handling and treatment.

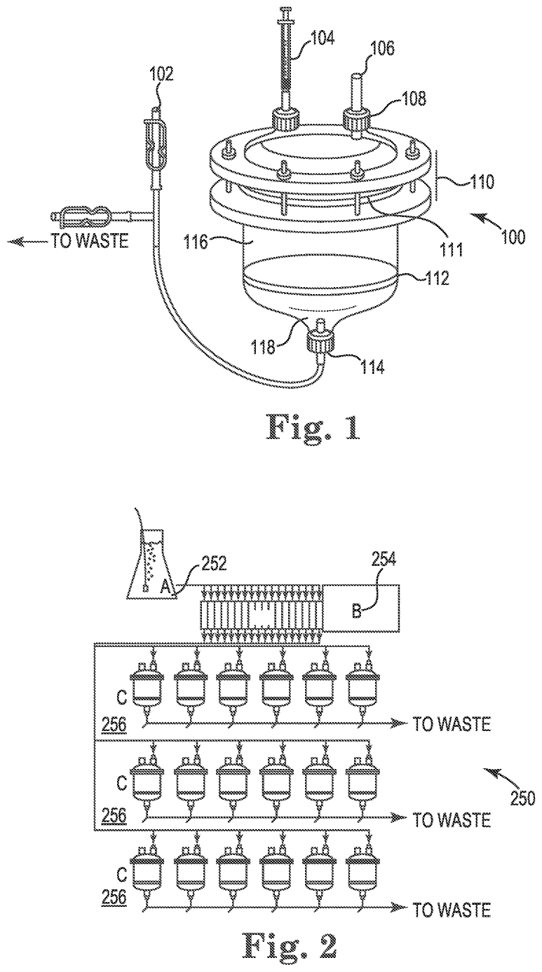

Referring now to FIGS. 1 and 2, FIG. 1 is a perspective view of an individual flow through toxicity glass test chamber 100 and FIG. 2 is a schematic of a continuous flow toxicity exposure system 250.

The size of an individual flow through toxicity glass test chamber 100 may be determined according to target sample size and throughput, and in this example is 250 mL. Test chamber 100 may generally comprise a chemistry sampling port 102; a manner of food introduction, such as through a septum 104; a test solution inlet 106; a threaded glass fitting with phenolic cap 108; a silicone O-ring-sealed glass flange 111; a full circumference aluminum flange clamp 110; liquid 112; and silicone tubing 114. Test chamber 100 also comprises chamber body 116 and chamber outlet 118.

Continuous flow toxicity exposure system 250 may generally comprise test solution 252; a multi-channel peristaltic pump 254; and exposure chambers 256 which can be expanded to as many as 36 or more simultaneous flow through test chambers like test chamber 100. Such a specialized exposure system 250 may be preferable for toxicity testing of potential aquatic toxicants on early life history stages of aquatic organisms, which are often relatively small and delicate (Wetzel. D. L. and E. S. Van Vleet, Cooperative Studies on the toxicity of dispersants and dispersed oil to marine organisms: A 3-year Florida study, Proceedings, 2001 International Oil Spill Conference, Global Strategies for Prevention, Preparedness, Response, and Restoration, API Publication No. 4686B. American Petroleum Institute, Washington, D.C. pp. 1237-1241 (2001); Goodbody-Gringley, G., D. L. Wetzel, D. Gillon, A. Miller, and K. B. Ritchie, Toxicity of Deepwater Horizon source oil and the chemical dispersant, Corexit® 9500, to coral larvae, PLOS One. Vol 8(1) e45574 (2013); and Delgado, G. A., Glazer, R. A. and D. Wetzel, Effects of Mosquito Control Pesticides on Competent Queen Conch (Strombus gigas) Larvae, Biol. Bull. 225:71-78 (2013). The exposure system may maintain a constant flow of toxicant solution by using, for example, a set of a multi-head peristaltic pump(s) equipped with multiple (e.g. 8-channel) roll pump heads to ensure adjustable but consistent flow rates. Platinum cured silicone tubing may be used to dispense the metered toxicant solutions.

### Example 3

Techniques for Measuring K. brevis Mortality

To measure K. brevis mortality in a liquid, the concentration of K. brevis is measured before any algaecides are added. An algaecide is then added, and the concentration of live K. brevis measured at intervals (e.g. 1, 2, 5, 10, 20, and 30 minutes). This may also be performed in serial stages. For example, if the mortality rate of K. brevis at 30 minutes is 100%, the experiment may be repeated and the concentration of K. brevis measured at a lesser time point, such as after 20 minutes. If the mortality rate of K. brevis is still 100%, the experiment may be repeated again with the concentration measured at a lesser time point, such as after 10 minutes. The experiment may be repeated as many times as necessary to measure how long it takes for an algaecide to reach 100% mortality rate of K. brevis. Any suitable time periods may be used to measure the concentration of K. brevis.

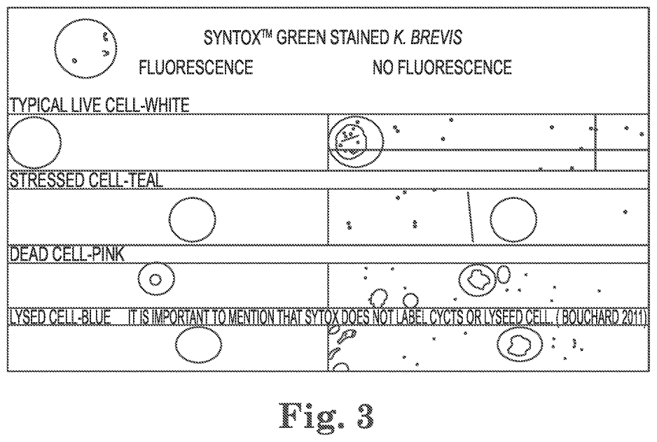

A variety of techniques may be used to measure K. brevis concentrations. In some embodiments, staining techniques are used. Staining may be performed with Lugol's Iodine Solution stain, which will become fixed to and stain the K. brevis so that it may be visualized. Other stains may be used, such as Invitrogen™ SYTOX™ Green from Thermo Fisher Scientific, which will penetrate compromised membranes (a feature characteristic of dead cells) of K. brevis and stain them. Fluorescein Diacetate may also be used, where live cells convert the fluorescein diacetate to fluorescein isothiocyanate (FITC) which fluoresces and may be measured. Additionally, 4′,6-diamidino-2-phenylindole (DAPI) may also be used to stain nucleic acids that are inside or outside of cells. In addition to staining methods, the concentration of K. brevis may also be measured by other imaging techniques such as manual count, microscopy, fluorometry, flow cytometry, or other possible staining or counting techniques. FIG. 3 depicts one method of measuring K. brevis concentration using Invitrogen™ SYTOX™ Green. In FIG. 3, a dead K. brevis cell that has been treated with SYTOX™ Green fluoresces green upon analysis and demonstrates the mortality of a K. brevis cell.

### Example 4

Treatment of K. brevis Strains Using Fatty Acid Algaecides

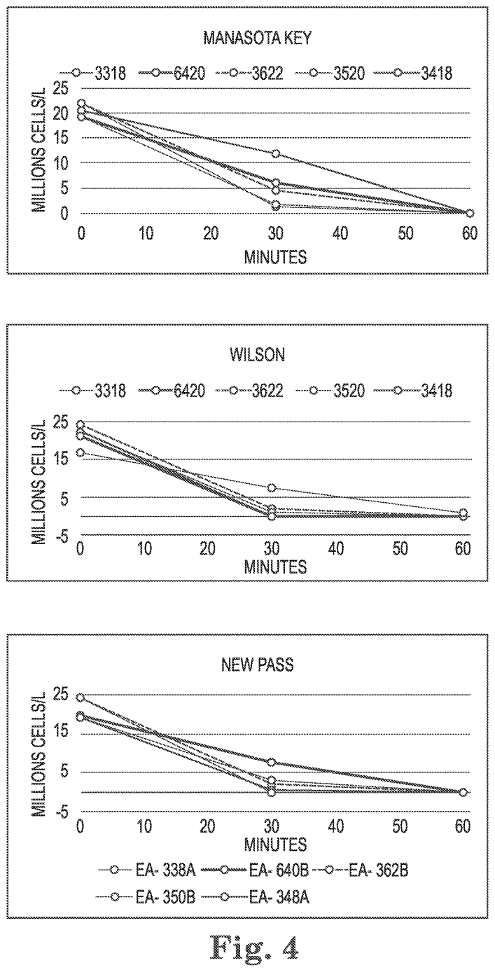

Three strains of K. brevis (Manasota Key, New Pass, and Wilson) were used at concentrations of 20 to 25 million cells/liter to test the efficacy of five algicidal unsaturated fatty acids from Table 1. The fatty acid concentrations were adjusted to provide 100%K. brevis mortality in under one hour. The results are shown in FIG. 4. The fatty acids and their identification numbers in FIG. 4 are shown below in Table 3:

TABLE 3
Identification Numbers

| Fatty Acid | Identification Number(s) |
|---|---|
| Alpha-linolenic acid | EA-338A or 3318 |
| Arachidonic acid | EA-640B or 6420 |
| Docosahexanoic acid | EA-362B or 3622 |
| Eicosapentaenoic acid | EA-350B or 3520 |
| Stearidonic acid | EA-348A or 3418 |

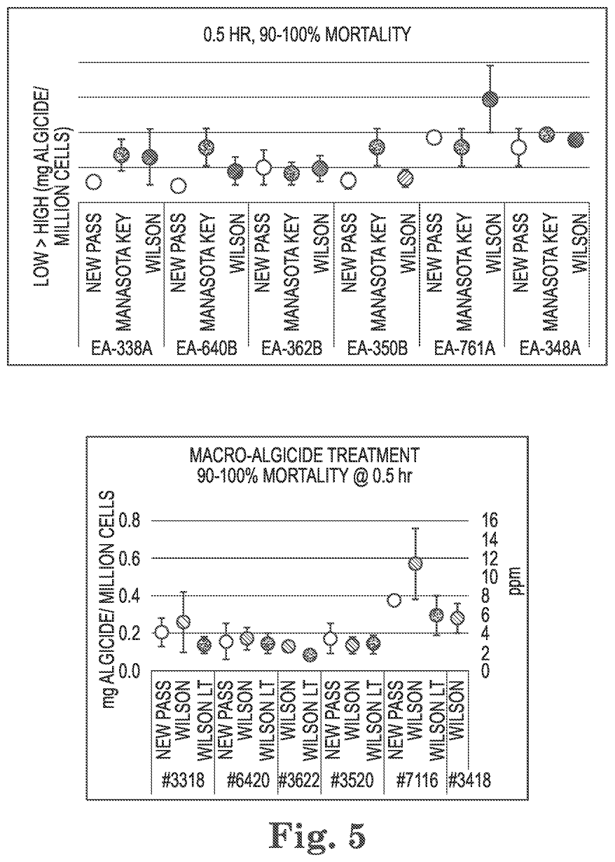

FIG. 5 shows two plots of the relative ratios of milligrams algaecides used per million K. brevis cells for the fatty acids in Table 2. Four strains of K. brevis were tested and the dosage of algicide applied to each strain was normalized relative to the number of K. brevis cells. The cultures of K. brevis were counted in a culture tube, and an equivalent dose of algicide was applied to each strain. Within 30 minutes, algicide treatment with the fatty acids in Table 1 resulted in 90-100% mortality of each strain of K. brevis.

### Example 6

Treatment of K. brevis Strains Using Fatty Acid Salts

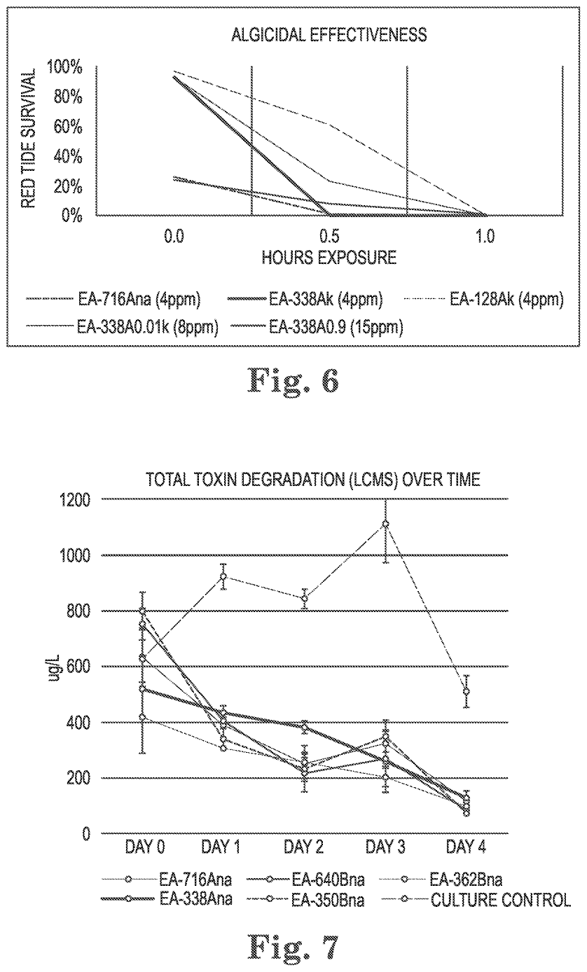

Using the method of Example 5, three strains of K. brevis were used at concentrations of 20 to 25 million cells/liter to test the efficacy of five algicidal unsaturated fatty acid salts from Table 2. The fatty acid salt concentrations were adjusted to provide 100%K. brevis mortality in under one hour. The results are shown in FIG. 6. The fatty acids and their identification numbers in FIG. 6 are shown below in Table 4:

TABLE 4
Identification Numbers

| Fatty Acid Salt | Identification Number(s) |
|---|---|
| Sodium palmitoleate | EA-716Ana |
| Potassium linolenate | EA-338Ak |
| Potassium ricinolenate | EA-H128Ak |
| Sodium Castorate | EA-338A0.01k |
| Linseed oil | EA-338A0.9 |

FIG. 7 shows a plot of the total toxin levels in a control sample containing six Type A toxins and 11 Type B toxins species over a four-day period, together with plots showing the total toxin levels in samples exposed to the five FIG. 6 salts. The BTX species present in the control sample are shown below in Table 5. Rapid and effective toxin reduction was obtained using all five salts.

TABLE 5

| Type-A BTX | Type B BTX |
|---|---|
| BTX-1 | BTX-2 |
| BTX-7 | BTX-3 |
| BTX-A2 | BTX-6 |
| BTX-A1/S-desoxy BTX-A2 | BTX-9 |
| BTX-A5 OA | BTX-B5 |
| | S-desoxy BTX-B2 |
| | BTX-B1 |
| | BTX-2 |
| | BTX-B5 open A ring |
| | BTX-B4 |
| | Gly-cys BTX-B |

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for Harmful Algal Bloom (HAB) mitigation or control, comprising the step of:
applying a water-soluble algicidal unsaturated fatty acid salt or soap, or a methanol-free solution of an unsaturated algicidal fatty acid, to water containing a HAB concentration, wherein the salt, soap or methanol-free solution reduces the HAB concentration.

2. The method of claim 1, wherein the water is selected from open water, flowing water, or other water that can contain a HAB.

3. The method of claim 2, comprising applying a water-soluble algicidal unsaturated fatty acid salt to the water.

4. The method of claim 2, comprising applying a water-soluble algicidal unsaturated fatty acid soap to the water.

5. The method of claim 2, comprising applying an aqueous solution of the water-soluble salt or soap to the water.

6. The method of claim 2, comprising applying an ethanolic solution of the salt, soap or fatty acid to the water.

7. The method of claim 2, comprising applying a dimethyl sulfoxide solution of the salt, soap or fatty acid to the water.

8. The method of claim 2, wherein the HAB comprises diatoms.

9. The method of claim 2, wherein the HAB comprises dinoflagellates.

10. The method of claim 2, wherein the HAB comprises cyanobacteria.

11. The method of claim 2, wherein the HAB comprises Karenia brevis.

12. The method of claim 2, wherein the HAB comprises the New Pass, Wilson, Wilson LT or Manasota Key strain of Karenia brevis.

13. The method of claim 2, comprising applying the salt or soap in a water-soluble encapsulating shell.

14. The method of claim 2, comprising applying the salt or soap and a gravimetric agent in a water-soluble encapsulating shell.

15. The method of claim 14, wherein the gravimetric agent is at least one of crushed stone, sand, or crushed shells of invertebrates.

16. The method of claim 2, comprising applying a salt, soap or methanol-free solution of a monounsaturated fatty acid.

17. The method of claim 16, wherein the monounsaturated fatty acid comprises a hydroxyl group.

18. The method of claim 2, comprising applying a salt, soap or methanol-free solution of ricinoleic acid or palmitoleic acid.

19. The method of claim 18, comprising applying a sodium, potassium or ammonium salt of ricinoleic acid.

20. The method of claim 2, comprising applying a salt, soap or methanol-free solution of a polyunsaturated fatty acid.

21-63. (canceled)
